(19) United States
(12) Patent Application Publication
(10) Pub. No.: US 2020/0390651 A1
(43) Pub. Date: Dec. 17, 2020

(54) SECURE MEDICAMENT CONTAINERS

(71) Applicant: 2 INNOVATORS, LLC, Naples, FL (US)

(72) Inventor: Sander S. Busman, Naples, FL (US)

(21) Appl. No.: 16/901,471

(22) Filed: Jun. 15, 2020

Related U.S. Application Data
(60) Provisional application No. 62/860,989, filed on Jun. 13, 2019.

(51) Int. Cl. A61J 1/03; A61J 1/14

(52) U.S. Cl. CPC A61J 1/03; A61J 2205/10; A61J 2205/50; A61J 1/1418

(57) ABSTRACT

In one or more particular implementations, a medicament case carrier is provided. Here, the medicament case carrier is provided in two parts. To secure the medicaments, a generally tubular body elongated along a longitudinal axis tubular body having an interior cavity and an open end is provided. The tubular body also includes an impact cushion is disposed within the interior cavity and configured to cushion the impact of a medicament case placed within the tubular body. The medicament case carrier also includes a cap suitable for selectively engaging the open end of the tubular body and designed to allow for selectively insertion or removal of a medicament case into or from said interior cavity; wherein the cap includes one or more input devices, a power supply and an output device.

### CROSS REFERENCE TO RELATED APPLICATION

The present application claims the benefit of U.S. patent application Ser. No. 62/860,989, filed Jun. 13, 2019, which is hereby incorporated by reference in its entirety.

### FIELD OF THE INVENTION

The present invention is directed to an apparatus for securing medicament containers.

### BACKGROUND OF THE INVENTION

Those skilled in the art appreciate that certain medicaments are sensitive to degradation or disintegration as a result of environmental conditions or due to mechanical stress. For example, and by no way limiting the disclosure herein, Nitroglycerin SL Tablets are packaged by pharmaceutical manufacturer in a glass amber bottle and dispensed in the same glass amber bottle by the pharmacist to the patient. According to the official package insert that is approved by the United States Food and Drug Administration, Nitroglycerin SL Tablets should be kept in the original glass container and tightly capped after each use to prevent loss of tablet potency. Since Nitroglycerin is very volatile and unstable, the finished dosage form of the Nitroglycerin SL Tablets benefits from being protected against extremes of heat, cold, air, moisture, and oxygen. If exposed to these conditions, the product is very likely to degrade and/or disintegrate and will cause the active pharmaceutical ingredient to be reduced in the product, reducing the therapeutic effect.

The type of conditions and how long the drug is exposed to environmental factors, will determine how much of the active pharmaceutical ingredient will be lost. Many patients use a pill fob or dispenser to hold their medicine. Thus, there is a chance of significant loss of therapeutic effect in their medicine if they are constantly removing the tablets from the carrier provided by the pharmacist and placing them into their own table case or fob. Since Nitroglycerin SL Tablets are indicated for the acute relief of an attack or acute prophylaxis of angina pectoris due to coronary artery disease and can be used lots of the time in an emergency situation, patients need the active pharmaceutical ingredient to be maintained and not degraded or disintegrated due to exposure to environmental factors and/or stress.

Thus, what is needed is a device that can effectively protect volatile medicaments from exposure to degrading and disintegrating from environmental effects and stress.

Furthermore, it is known in the art that consuming expired medicines may have negative consequences for the patient. The expiration date for most medicines can be found printed on the label or stamped onto the bottle or carton. According to the US FDA, expired medical products can be less effective due to changes in chemical composition or decreases in strength. Certain expired medications are at risk of bacterial growth and sub-potent antibiotics can fail to treat infections, leading to more serious illnesses and antibiotic resistance. Thus, what is also needed in the art is a mechanism for alerting a user to when the medicine that they have stored has expired or needs to be refilled.

While elements of these devices are known, for example, U.S. Pat. Nos. 4,756,407, 7,597,196, 6,667,936 4,955,480 4,054,208, 6,793,076, 5,695,090 and Patent Application No. 20130292403 each incorporated herein by reference as if presented in their respective entireties, teach medicament containers or date notification systems. However, each of the foregoing do not describe the features of the apparatus and systems described herein.

### SUMMARY OF THE INVENTION

In a particular implementation, a medicament case carrier apparatus is described providing a generally tubular body elongated along a longitudinal axis having an interior surface defining an inner cavity, a closed end and an open end that permits access to the inner cavity. The body further comprising an inner vessel having an inner surface, an outer surface and a top rim flange extending orthogonally from the longitudinal axis of the tubular body, an outer vessel having an inner surface, an outer surface and a top rim. The top rim flange of the inner vessel is configured to be coextensive with the top rim of the outer vessel so as to form a cavity between an inner surface of the outer vessel and the outer surface of the inner vessel.

The medicament case carrier also includes a cap disposed at the open end of the body for selectively allowing insertion or removal of a medicament container into or from said interior cavity; wherein the cap includes one or more securing elements configured to secure a portion of the inserted medicament container. The medicament case carrier also include one or more display devices configured to display a date corresponding to the expiration date of the medicament contained within the medicament case.

In one or more additional or alternative implementations, a medicament case carrier is provided with a generally tubular body elongated along a longitudinal axis. Here, the tubular body has an interior cavity and an open end. The tubular body also includes an impact cushion disposed within the interior cavity and configured to cushion the impact of a medicament case placed within the tubular body. The medicament case carrier also includes a cap suitable for selectively engaging the open end of the tubular body and designed to allow for the insertion or removal of a medicament case into or from said interior cavity. Here the cap includes one or more securing elements configured to secure a portion of the inserted medicament container when the cap is secured to the tubular body.

### BRIEF DESCRIPTION OF THE DRAWINGS

The medicament case carrier is illustrated in the figures of the accompanying drawings which are meant to be exemplary and not limiting, in which like references are intended to refer to like or corresponding parts, and in which:

FIG. 1A provides an illustration of the medicament carrier according to a particular embodiment.

FIG. 1B provides an illustration of the medicament carrier with the cap in the disengaged configuration according to a particular embodiment.

FIG. 1C provides an illustration of a side view of the medicament carrier.

FIG. 1D shows a further side view of one configuration of the medicament carrier.

FIG. 1E illustrates a bottom view of the medicament carrier according to a particular embodiment.

FIG. 1F illustrates a top view detailing display elements of the medicament carrier.

FIG. 1G is a schematic diagram detailing the electronic elements of the described medicament carrier.

FIG. 2A illustrates a side, cross-sectional view of one or more elements of the medicament holder according to a particular embodiment of the present invention

FIG. 2B illustrates a side, cross-sectional view of one or more elements of the medicament holder according to a particular embodiment of the present invention.

FIG. 2C illustrates a top, cross-sectional view of one or more elements of the medicament holder according to a particular embodiment of the present invention.

FIG. 3 shows a top, cross sectional view of one or more elements of the medicament holder according to a particular embodiment of the present invention.

FIG. 4 shows an alternative top, cross sectional view of the medicament holder according to a particular embodiment of the present invention.

FIG. 5A shows a side view of the medicament holder according to a particular embodiment of the present invention.

FIG. 5B shows a side view of the medicament holder according to a particular embodiment of the present invention.

FIG. 6 shows a side view of the medicament holder according to a particular embodiment of the present invention.

FIG. 7 shows alternative implementations of one or more features of the present invention.

FIG. 8 shows alternative implementations of one or more features of the present invention.

### DETAILED DESCRIPTION OF CERTAIN EMBODIMENTS OF THE INVENTION

By way of overview, various embodiments of the apparatus described herein are directed to providing environmental protection to a medicament case. For instance, the foregoing describes an apparatus to hold a medicament case during personal travel so that the contents of the medicament case, such as environmentally sensitive medicament, are not damaged or degraded or disintegrated due to exposure to environmental factors. While the dimensions provided are exemplary, it will be appreciated that the various relative dimensions of the elements and/or features described can be altered depending on intent, use and applicability.

As used herein, a medicament case 101 is any container for carrying medicines, such as tablets, pills or capsules. In one or more implementations, the medicament case 101 is a generally tubular storage container having a removable or engagable cap or lid. For example, the medicament case is a pharmacy provided proscription bottle. Such medicament cases are used to store a complete course of medicine or an amount of medicament provided by a pharmacist or other health care provider. Typically, such medicament case are provided by pharmacists in connection with a prescription and include a generally tubular body, and a screw-cap lid.

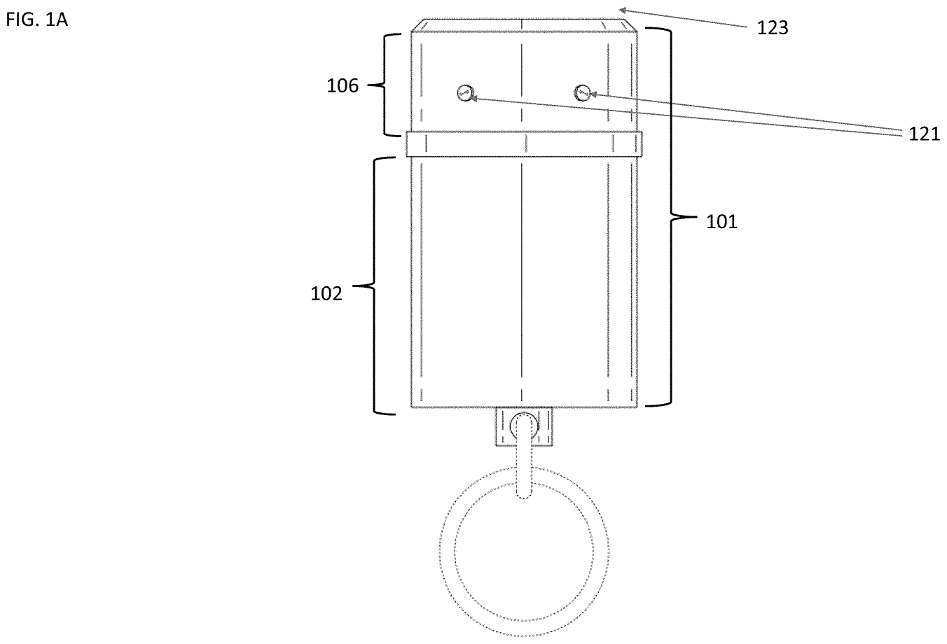

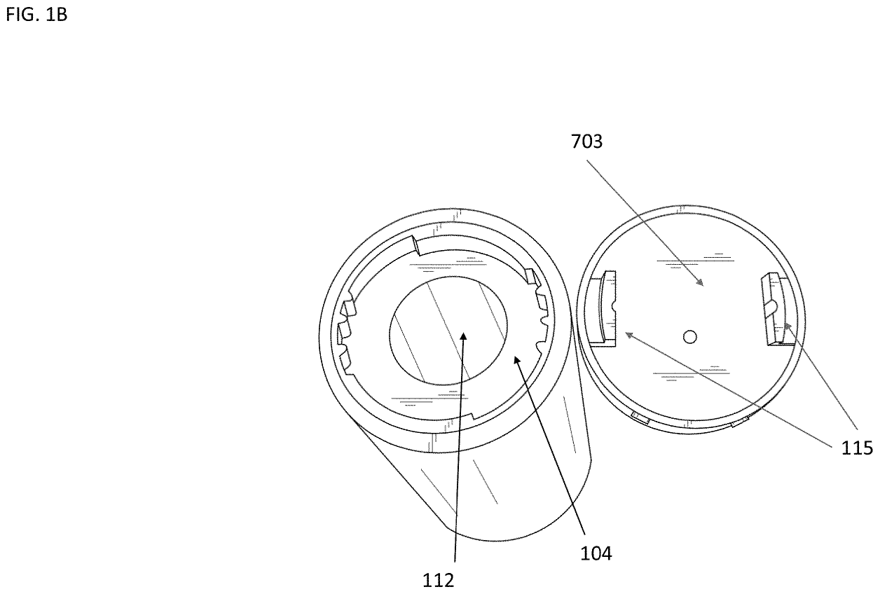

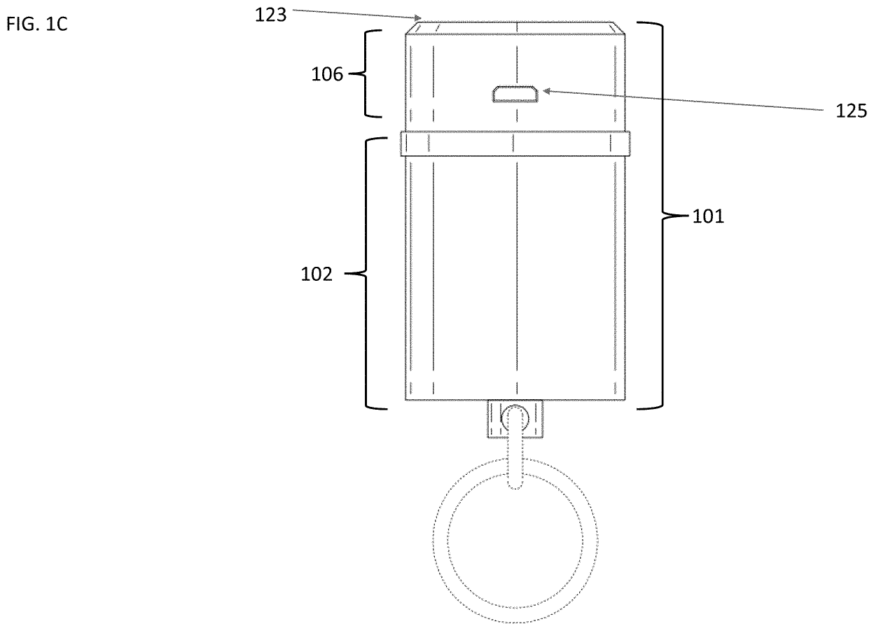

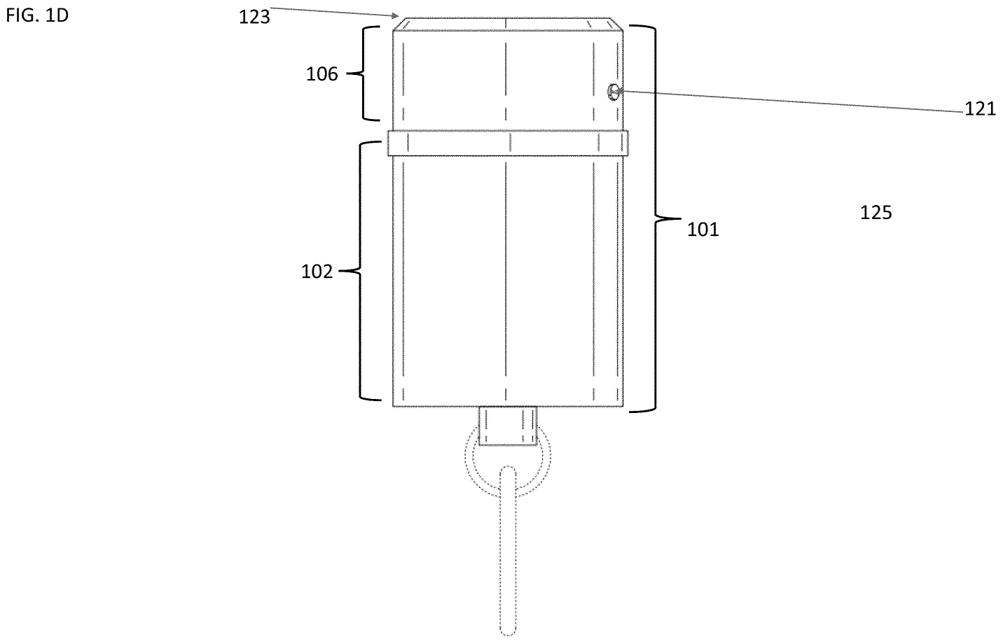

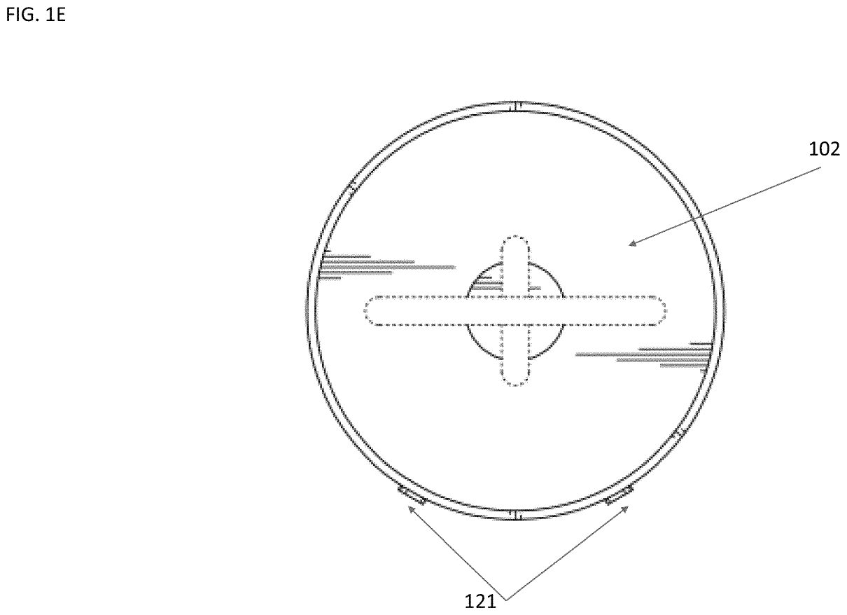

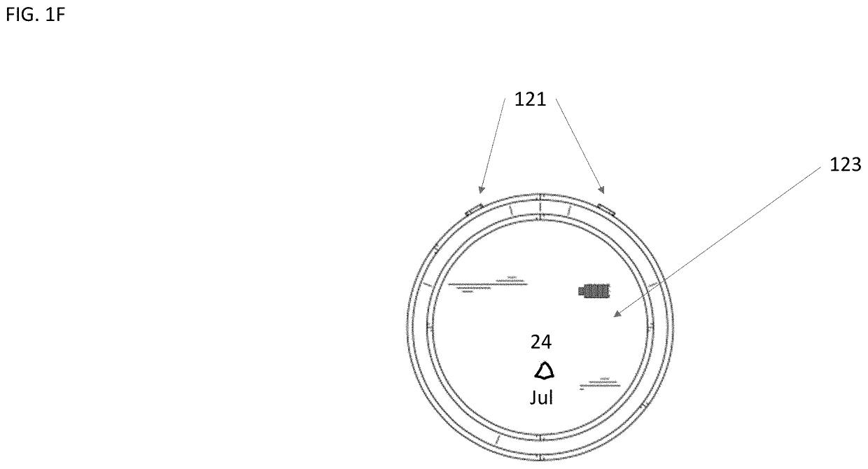

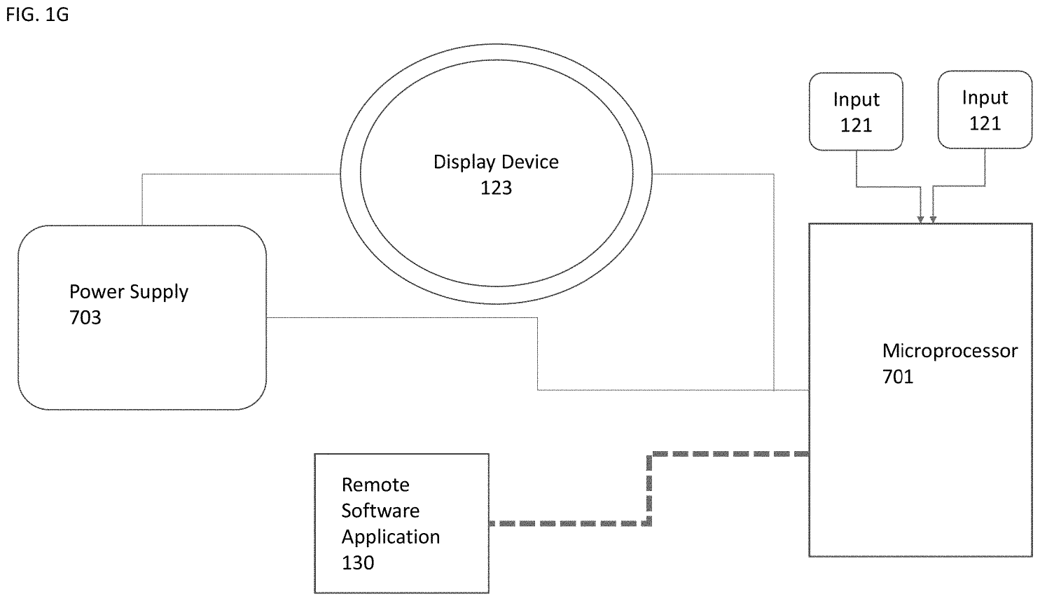

Turning to FIG. 1A, the medicament case carrier 101 includes a body 102 configured to accept a medicament case. In one particular implementation, the body 102 is an elongated tubular body. In another implementation, the body 102 is configured as a cubic or rectangular body. In a further implementation, the body 102 is configured as an ovoid body. It will be appreciated that various shapes of the body 102 are contemplated so long as such shapes meet the goals stated herein. For instance, the body 102 is configured to receive a standard medicament case, such as a standard or standardized prescription or pharmacy medicine container.

As shown in FIGS. 1A-1B, 2A-2B, and 3-4 the body 102 includes an interior cavity 112. The interior cavity 112 is configured to accept a medicine or prescription drug bottle. For example, the interior cavity has a diameter that is larger than the diameter of a prescription bottle and/or its cap.

In one or more implementations, the body 102 is formed at least in part of a metal, plastic, or composite material. For instance, in a particular implementation, the body 102 is formed of one or more metals or alloys. In another implementation, the body of formed of one or more plastic or synthetic materials, such as but not limited to, carbon fiber, plastics, resins or other similar materials.

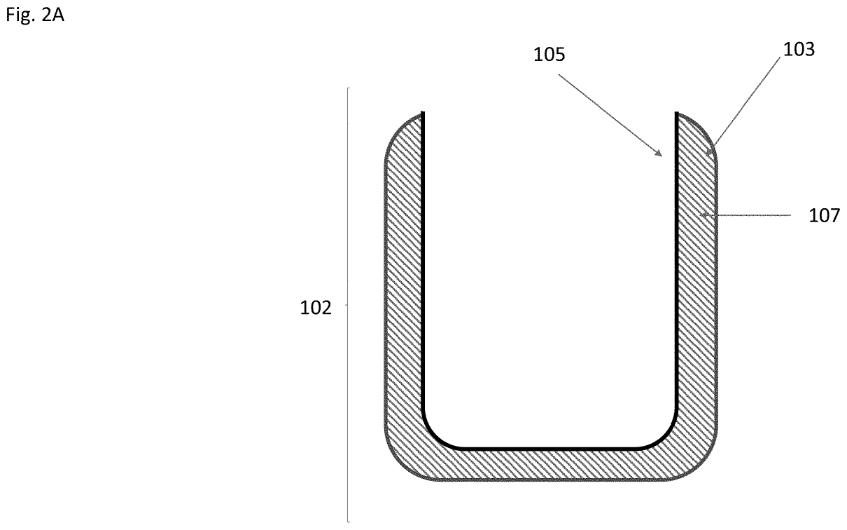

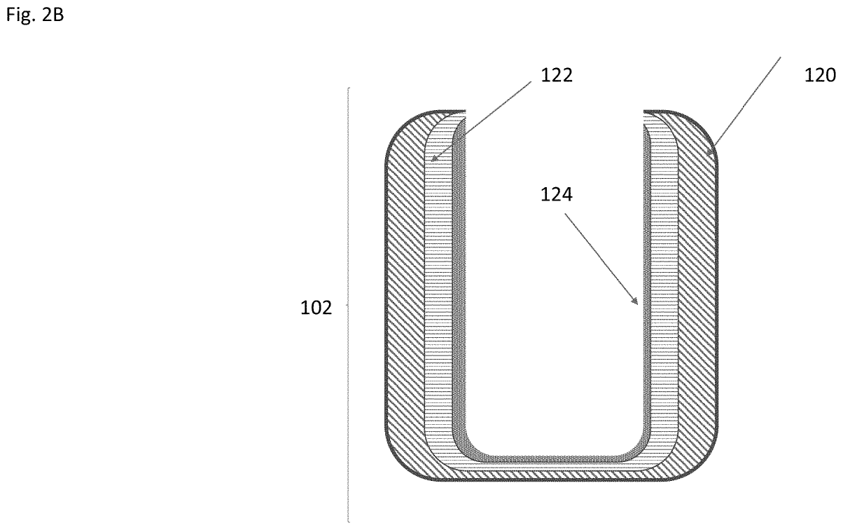

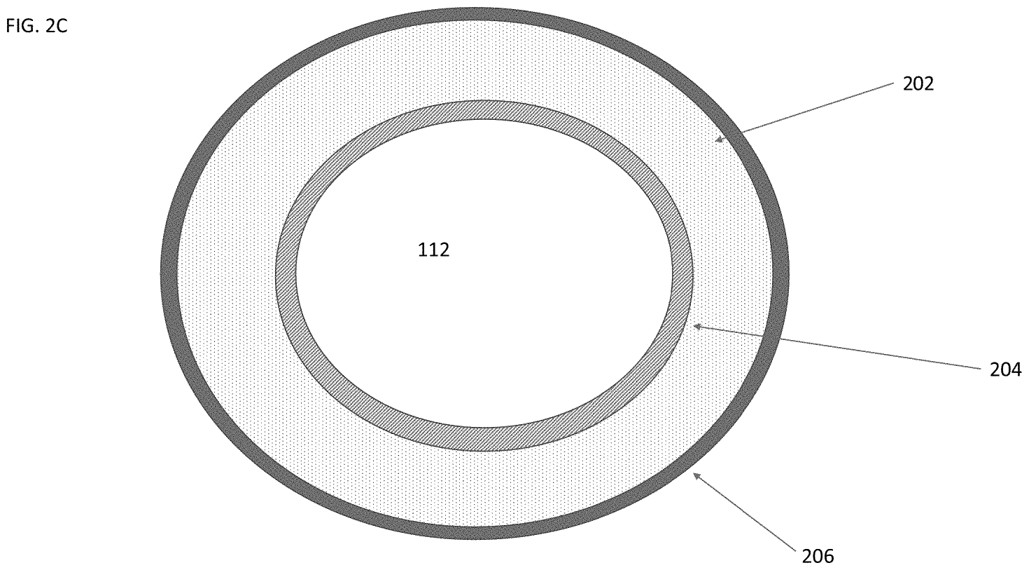

In yet a further implementation, as shown in FIG. 2A, the body 102 is formed of one or more combinations or composites of materials or layers of materials. As shown in FIG. 2A, the body 102 has an outer surface 103 and an inner surface 105. The inner surface 105 and the outer surface 103 enclose area 107. In one or more implementations, the enclosed area 107 defines a space devoid or air, such as a vacuum In another configuration, the enclosed area 107 is filled with one or more insulating materials.

In an alternative implementation, as shown in FIG. 2B, the body 102 is formed of an outer layer 120, an intermediate layer 122 and an inner layer 124. Such layers can be formed of synthetic materials, plastics, resins, foam, composite materials, or metals such as copper or stainless steel. Here, each of the outer layer, intermediate and inner layers are formed of different materials.

In such a particular implementation, the layers may be selected for various characteristics. For instance, the layers can be selected based on insulating properties, shock absorption properties, gas permeability or other characteristics that are relevant to protecting volatile products from external factors. By way of non-limiting example, a body 102 is provided where the outer layer is formed of a first material, a middle, or series of middle layers, are formed of a second material having different or specific characteristics, and an inner layer is formed of a third material type. For example, the first layer is selected from materials having a high impact resistance, the second layer is selected from materials having thermally insulating properties, and a third layer selected from materials having flexibility or are suitable for use as shock absorbing materials. However, each layer can comprise a composite material or multiple layers of material having different properties. For instance, the first, second or third layer is a composite layer of a non-metal insulating material sandwiched two metal sheets. Alternatively, the inner and outer layers are formed of the same material or composite of materials.

In yet a further implementation as shown in FIG. 2C, the body 102 includes at least one airless chamber 202 disposed between an outer layer 206 and an inner layer 204. For instance, the outer layer 206 is separated from the inner layer 204 by a vacuum chamber 202 that reduces the transfer of thermal energy of heat or cold from the exterior or interior of the body 102 to the outside environment. It will be appreciated that the bottom portion of both the inner layer and the outer layer may be in contact with one another. However, in certain configurations, the inner layer is separated at the base or bottom portion of the body 102 and is not in contact therewith.

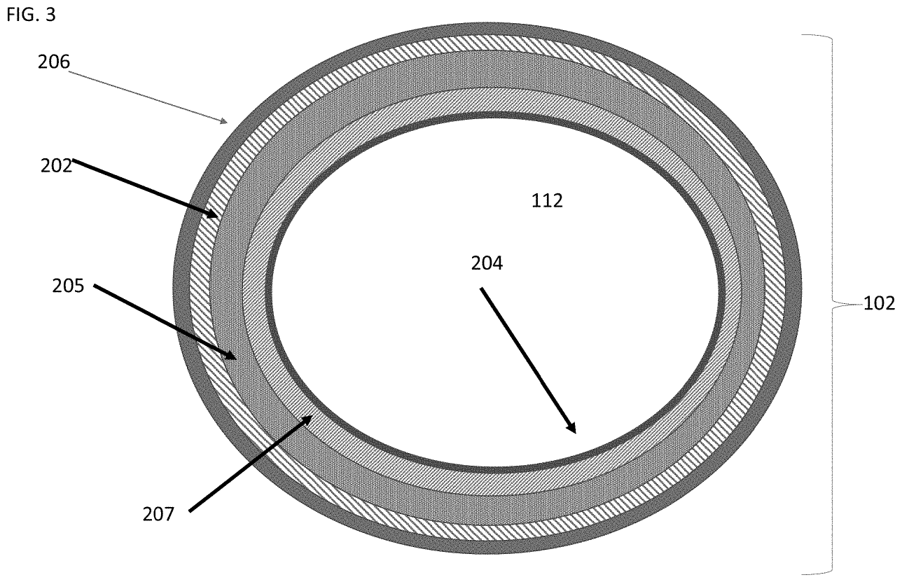

In an alternatively configuration as shown in FIG. 3, the outer layer of the body 102 is separated from the inner cavity 112 of the body 102 by at least two vacuum chambers. Here, a first layer of material, such as the outer layer 206, is separated from an intermediate layer 205 by a vacuum chamber 202 devoid of air or other materials. The inner layer 204 is separated from the intermediate layer 205 by second space or void 207.

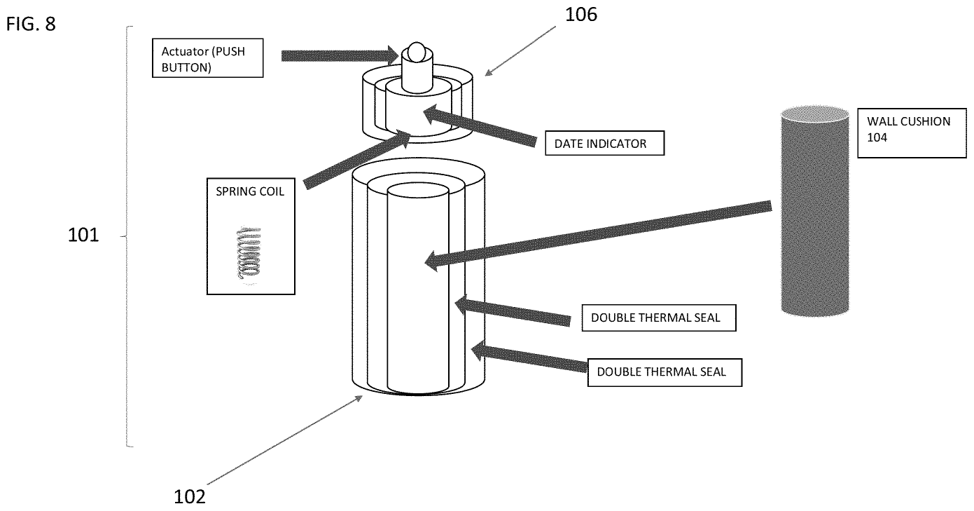

Returning to FIG. 1B, a shock absorbing insert 104 may be secured within the interior cavity 112 of the body 102. In one or more configurations (such as the configuration provided in FIG. 8), the shock absorbing insert 104 is configured as a cylindrical tube that is placed within the interior cavity 112 of the body 102 and provides cushion to the medicament container 101. In one implementation, the shock absorbing insert is removable. In an alternative configuration, the shock absorbing insert is not removable and is coextensive with the inner surface of the body 102. In one or more further implementations, the shock absorbing insert 104 is configured with an internal cavity open at one end. Thus, when a medicament container 101 is placed within the inner cavity of the body 102, it is secured within the internal cavity of the shock absorbing insert 104.

Here, the shock absorbing insert 104 is formed of a compressible or shock absorbing material. For instance, the shock absorbing material 104 is formed of materials such as molded or expanded polystyrene, polypropylene, polyethylene, polyurethane, molded pulp, extruded or spun natural fibers, resins, and the like.

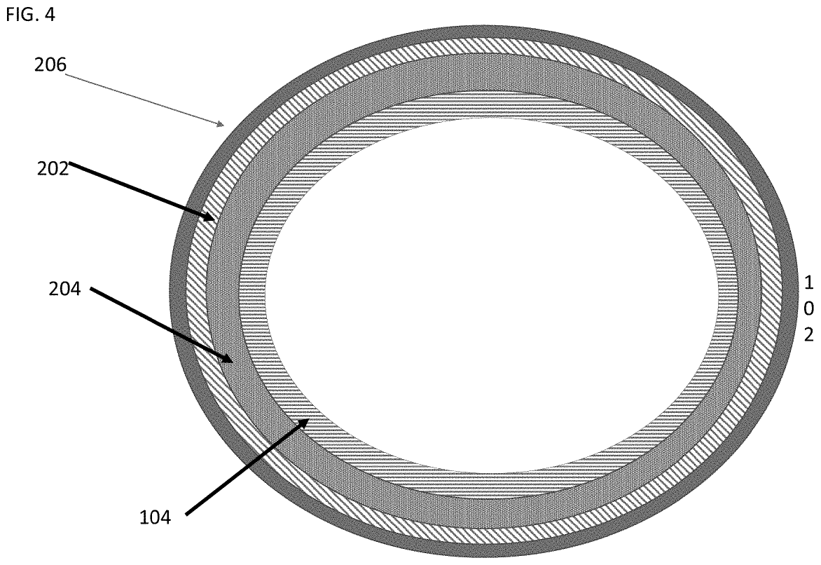

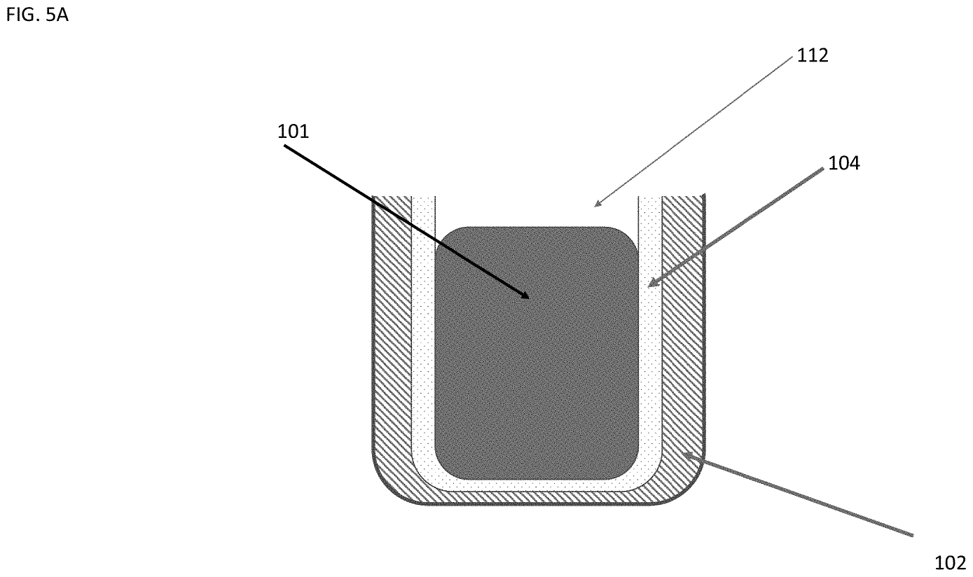

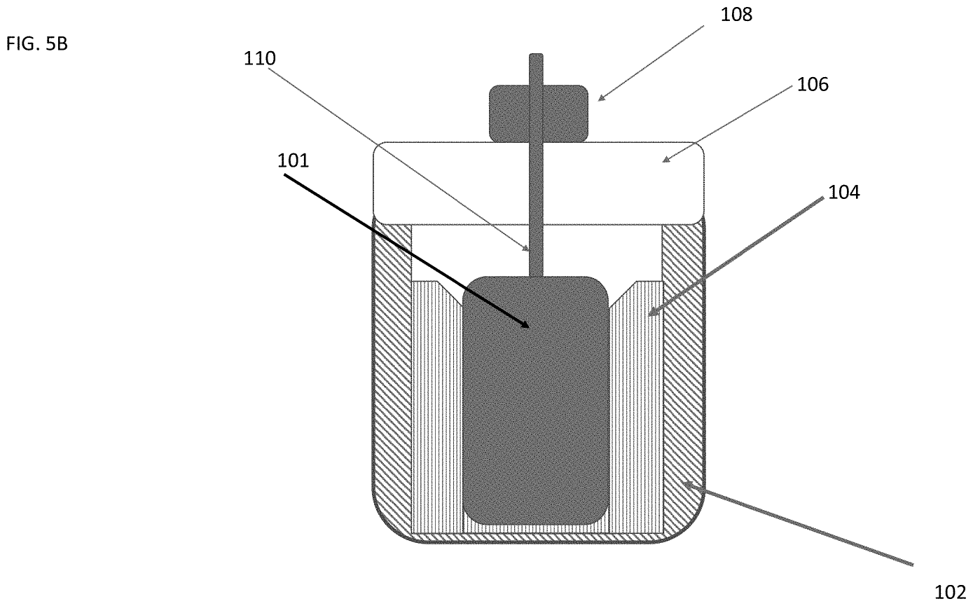

As shown in FIGS. 4 and 5A the shock absorbing insert 104 is configured to fit within the cavity 112 formed in the body 102. In turn, a medicament case 101 is secured within the cavity defined by the shock absorbing insert 104. As the dimensions of a medicament case 101 can change between uses or users, the shock absorbing insert 104 is formed of compressible material such that medicament case having a cross section larger than the diameter of the cavity of the shock absorbing insert can be accommodated.

In one particular implementation shown in FIG. 5B, the cavity defined by the shock absorbing insert 104 has a larger diameter at a top portion than at a bottom portion. For example, the top portion of the shock absorbing insert 104 is chamfered. Here, the chamfered portion forms a cone-like structure that permits medicament case 101 having a larger diameter than the diameter of the lower portion of the shock absorbing insert 104 to be secured within the apparatus described.

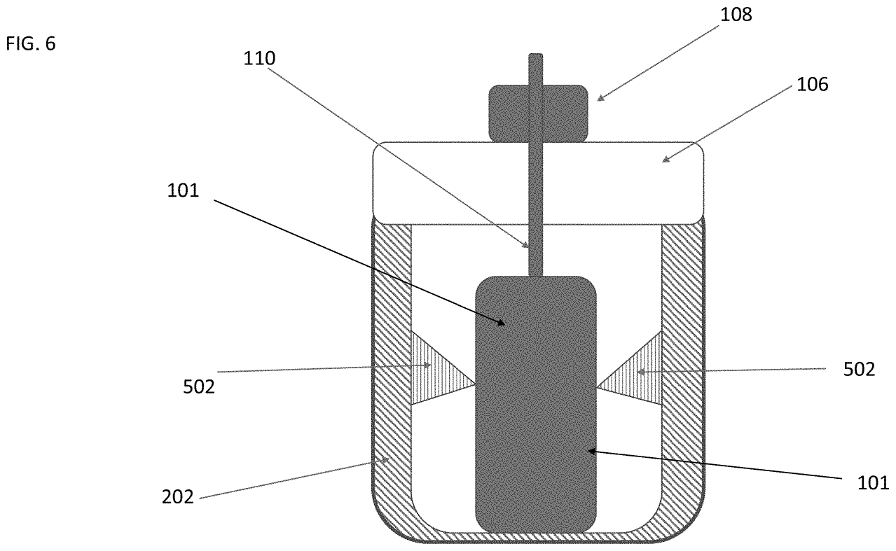

In an alternative configuration shown in FIG. 6, the shock absorbing insert 104 is formed as one or more rings or cylinders of shock absorbing material 104 disposed along a portion of the longitudinal length of the body 102. Here the rings or cylinders have protrusions, flanges, flaps or other extending structures 502 that extend into the cavity of the body 102. Upon insertion of a medicament case 101 into the central cavity, the extending structures 502 are deformed and resiliently press on the medicament case 101 and maintain its position. In this way, a variety of different types of medicament containers can be secured without the necessity of providing medicament container carriers of varying dimensions.

Returning to FIGS. 1A-1D and 1E the medicament case 100 also includes a cap 106 suitable for selectively engaging the open end of the tubular body 102 and designed to allow for insertion or removal of a medicament case 101 into or from said interior cavity 112.

In one or more implementations, the cap 106 is configured with threads that mate with threads (not shown) on the body 102 that allow the cap to be secured to the body 102. In an alternative configuration, the cap 106 is configured to be inserted into the inner cavity of the body 102. Here, and in alternative implementations, the cap 106 may have the same material and structure as the body 102. For instance, the cap 106 includes one or more layers of material so as to define a first and second layer having insulating properties. In a further arrangement, the cap 106 and/or body 102 is equipped with one or more attachment devices, such as magnets, clamps, clips or the like that allow the cap 106 and body 102 to be secured to one another.

In a particular implementation as shown in FIG. 5B, the cap 106 is equipped with an actuator 108. The actuator 108 causes the activation of a plunger or arrestor that presses on the medicament case 101. For example, the actuator 108 causes the release of a spring secured tab, shaft or flange 110. Upon release, the flange or tab presses upon the medicament case 101 and prevents vertical movement within the medicament container case 100. In an alternative implementation, the actuator 108 causes the release of a shaft without the use of a spring. Here the shaft is equipped with a series of notches or depressions. When the shaft makes contact with the medicament case 101, the actuator 108 causes the shaft to lock into its present position and prevent the medicament container 101 from moving. In one or more configurations, the shaft, flange or tab 110 has a maximum length of no more than half the total length of the carrier apparatus. In a further arrangement, the shaft, flange or tab 110 has a maximum length of no more than ⅓^{rd} the total length of the carrier apparatus.

In one or more configurations, the cap 106 includes at least a microprocessor 701, user input devices 121, a power supply, 703 and a display device 123. In a further implementation, the cap 106 includes one or more shock absorbing or arresting elements 115, as shown in FIG. 1B. In one particular implementation, the arresting elements 115 are configured so as to abut the cap of a medicament container 101 when the medicament container or case 101 is inserted into the body 102 and the cap is affixed. For example, the arresting elements 115 are configured such that when the cap 106 is secured over the body 102, the arresting elements 115 secure the top (or cap) of the medicament case 101 within the arresting elements. Such an arrangement provides additional mechanisms to prevent the movement of the medicament case 101 during use or transport. In a further implementation, the arresting elements 115 are configured with one or more notches or groves that are configured to accept one or more nurbs or bumps placed on the cap or end of a medicament holder. Such an arrangement provides additional support for the medicament container 101. In an alternative implementation, the cap 106 further includes at least shock absorbing elements 115 configured to extend into the interior cavity where the distance between the at least two is no more than 1.0% of the total width of a cap of the medicament holder. In one particular implementation the distance is no more than 0.5% of the total width of a cap of the medicament holder. In a further implementation, the distance between the shock absorbing elements in no more than 0.33% the width of a cap of the medicament holder.

In one implementation, the microprocessor 701 includes one or more microprocessors, microelectronics, or control circuitry and associated components. In this configuration, the microprocessor 701 allows for the processing of the input signals generated by the input devices 121 and provides output signals to the display device(s) 123. In one or more further configurations, the control devices 701 include one or more communication interfaces.

For instance, the cap 106 includes a microprocessor 701 that is configured to communicate with one or more remote programming devices (not shown) through RF frequencies, such as but not limited to RF signals, WiFI, RFID, Near Field Communication, Bluetooth, or other wireless communication channels. The remote programming devices can be one or more computers configured to transmit data to the microprocessor by wireless or wired means. In one implementation, the remote programming device can be a smart phone, tablet computer, desktop computer, custom hardware device or other device configured with a wireless transmitter or serial interface that allows for the bi-directional exchange of information.

As shown in FIG. 1G, automatically setting the current date as well as the expiration date or refill date can, in one implementation, include accessing a software application 130 running on the remote programming device and selecting or receiving a derived or determined expiration date or refill date. For example, the medicament container can include one or more indications as to the expiration date. The software application 130 executing on the remote programming device is configured to receive an optical scan the expiration date of the medicament case 101 and parse the expiration date. For example, the software application 103 uses one or more optical character recognition software modules to parse the expiration date provided with the medicament case (such as on a label associated therewith). In an alternative configuration, the medicament case 101 includes one or more QR, barcodes or other identifiers that can be scanned and evaluated by the software application 103 in order to derive the expiration date. Using this parsed date, the software application transmits (wired or wirelessly as depicted in dashed lines) to the microprocessor 701 data that includes the parsed expiration date. Thus, the expiration date is set automatically. In a further implementation, the current date is provided by the software application.

Alternatively, the user can set the expiration date of the medicament container, and any other date manually using the input devices. For example, the user is able to set the current date using the input devices as well as the anticipated expiration date of the medicament. For example, manually setting the date includes using one or more input devices 121 to advance set a date in the future for the expiration of the medicament.

In one particular implementation, as shown in FIGS. 1A, 1C-D, and 1F, the cap 106 further includes a display device 123. For example, the display device 123 is a screen or other mechanism configured to output visual information to a user. In one or more further configurations, the cap 106 also includes one or more control interfaces 121. In one particular implementation, the control interfaces 121 are buttons, touch pads, sensors, or other mechanisms configured to register a user's desire to intimate a control signal or flag to a control device or processor. In a particular implementation, the cap includes two control interfaces.

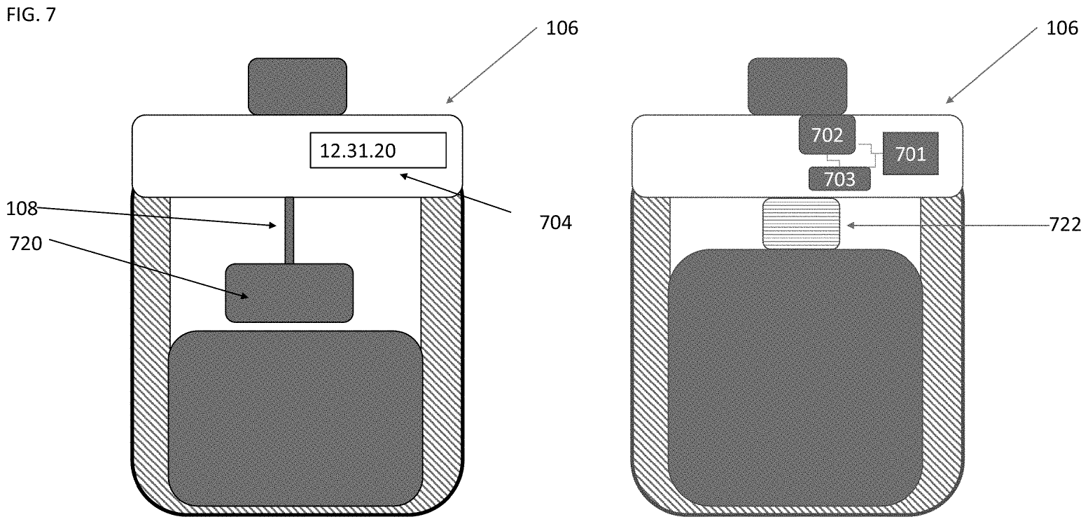

In one configuration, the display device 123 provides a user with information relating to a relevant date regarding the medication. For instance, the display device is configured as a screen that displays the expiration date or time for refill of the medicament contained within the medicament container. In one or more configurations as shown in FIGS. 1F-1G and 7, the display device 123 (or 702) is an electronic display. For example, in one non-limiting arrangement, the display device 123 is a LED, LCD or E-Ink array of addressable elements connected to one or more microprocessors and configured to receive a data signal therefrom.

In one or more further implementations, the relevant dates for display to a user are set using the control interfaces 121. For instance, a user is able to select, using the control interfaces 121, a current date. Likewise, the user is able to use the control interfaces 121 to set the target or expiration date of the medication. By way of non-limiting example, one or more control interfaces are used to advance selection of dates provided by the microprocessor 701 and displayed on the display device 123 such that the user is able to select a desired date. Here, each control interface 121 (i.e. button), allows for a different degree of selection. For instance, one control interface allows for the microprocessor progression of months, while a different control interface allows for a progression of years. Such progression can be used to set a start date, as well as an expiration date of the medication. Alternatively, the control interfaces can be used to select from a listing of pre-set terms or durations (i.e. 10 days, 20 days, 3 months, 6 months) for a given medication that will begin to run from the current selected date.

Once the relevant dates have been set, a processor or timing circuit, such as microprocessor 701, that is integral to the cap, is configured by one or more software modules or code executing therein to cause the date set by the user using the input devices to advance, in real time, until the expiration date. At any time, the user may activate the display device 123 (such as by pressing one or more of the input devices 121) and be presented with the current date, the expiration date, or the amount of days remaining until the expiration date, or some combination thereof.

Upon reaching the set expiration date, microprocessor 701 is configured by code executing therein to provide an alert to the user. For example, the display device 123 is configured to blink, flash, change colors, or otherwise execute an alert routine. Such alert routines can be stored in one or more data storage or data memory devices that are accessible to the microprocessor 701. In one or more configurations, an audio output device is also provided (not shown). In one or more implementations, the audio output device is configured to receive a signal from the microprocessor 701. For instance, when the microprocessor 701 determines that the present time matches the pre-set expiration date, a signal is sent to the audio device. Such signal causes the audio device to generate an audible alert. In one arrangement the upon reaching the preset expiration date, both the display device and the audio device produce human perceptible alerts. For example, the display device 123 is configured to undergo a visual change (i.e. flashing, color changes, etc.) and the audio device produces a human perceptible alert sound. In one or more implementations, such alerts (both visually and audibly) are configured by the microprocessor to continue until it receives one or more input sequences provided by a user of one or more of the control interfaces 121.

In a further implementation, upon expiration or refill of the medicament, a signal can be sent to the remote programming application 130 though wireless or wired means. From here, the remote programming application 130 causes a remote computing platform (such as a smartphone) to generate an alert or message to the user. Alternatively, in configurations where the cap 106 may include one or more notification devices, the expiration or refill of the medicament will cause the notification devices to notify the user. Here, notifications devices can be speakers, lights, vibratory elements or the like that are connected the power supply incorporated into the cap 106. In one or more configurations, upon reaching the expiration date, the medicament holder is configured to communicate with one or more remote servers, databases, APIs, websites or computers to update the status of the user's medication.

As shown in FIGS. 1C, 1G and 7, in particular configurations that include one or more display devices, the cap also includes a power source 703 (such as a battery). In one particular implementation, the power source 703 is a rechargeable battery. Such a rechargeable batter is recharged by connecting it to an external power source using power interface 125. In a further implementation, the power interface 125 is configured to also allow for bidirectional communication between the microprocessor 701 and one or more remote computers.

In one or more configurations, the power source 703 is integral to the cap, such that it is not removable. In another implementation, the power source 703 is a removable single use battery, such as an AA, AAA, disc or other battery type that is sufficient for the purposes and functionality described herein.

In one or more implementations, the battery is stored within the cap 102 in a battery compartment that is accessible via a secured panel. In one or more configurations, the battery removable from the cap using one or more tools, such as a screwdriver or other access device. For example, the battery compartment is secured with one or more screws. In a further configuration, the access device is attached to the body 102 via one or more attachment configurations. In one particular configuration, the access device is attached to the body 102 using flexible links or cables that are permanently secured to both the access device and the body 102.

Thus, by placing a date indicator on the top of the apparatus described herein, the device provides extremely useful information to the user indicating when they need to discard their current medicine and get a refill.

In one or more specific configurations, the use of the control interfaces in combination (e.g. simultaneously) allows for the device to be reset or to trigger another functionality. Furthermore, the functionality of the overall device can change based on the subject matter displayed by the display device. For example, where the display device 123 displays particular information, such as that the expiration date has been reached, then one or more selection of the control interfaces allows the device to be reset.

In one or more implementations, as shown in FIGS. 7 and 8, the cap 106 includes a mechanical date indicator. Here, the date indicator 704 is set to the expiration date or time for refill of the medicament contained within the medicament container, as shown in FIG. 7. In one or more implementations, the date indicator 704 includes manually selectable elements that allow the expiration date or refill date to be set. For instance, the day, month and year of the expiration or refill date of the medicine is set manually by dial, jog wheels or sliders. In such a configuration, each date and component of a date (e.g. day, month, year) is encoded on a portion of a dial or slider and the user manually selects the determined expiration date.

In a further arrangement as shown in FIGS. 7-8, the actuator 108 is equipped with an arrestor plate 720. The arrestor plate is configured to push down on the medicament container and secure it from vertical movement within the medicament holder. In another arrangement, the cap 106 is configured with a shock absorbing material 722, such as a cushion. In this arrangement the cushion can be deformable under compression. As such, the cushion 722 can be used to secure medicaments of varying dimensions.

While this specification contains many specific embodiment details, these should not be construed as limitations on the scope of any embodiment or of what can be claimed, but rather as descriptions of features that can be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features can be described above as acting in certain combinations and even initially claimed as such, one or more features from a claimed combination can in some cases be excised from the combination, and the claimed combination can be directed to a sub-combination or variation of a sub-combination.

Similarly, while operations may be depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the embodiments described above should not be understood as requiring such separation in all embodiments, and it should be understood that the described program components and systems can generally be integrated together in a single software product or packaged into multiple software products.

The terminology used herein is for the purpose of describing particular embodiments only and is not intended to be limiting of the invention. As used herein, the singular forms “a”, “an” and “the” are intended to include the plural forms as well, unless the context clearly indicates otherwise. The use of “including,” “comprising,” or “having,” “containing,” “involving,” and variations thereof herein, is meant to encompass the items listed thereafter and equivalents thereof as well as additional items. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof. It should be noted that use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. Also, the phraseology and terminology used herein is for the purpose of description and should not be regarded as limiting.

Particular embodiments of the subject matter described in this specification have been described. Other embodiments are within the scope of the following claims

Citation of any above publications, patents, patent applications or documents is not intended as an admission that any of the foregoing is pertinent, nor does it constitute any admission as to the contents or date of these publications or documents. All references cited herein are incorporated by reference to the same extent as if each individual publication and references were specifically and individually indicated to be incorporated by reference.

While the invention has been particularly shown and described with reference to a preferred embodiment thereof, it will be understood by those skilled in the art that various changes in form and details may be made therein without departing from the spirit and scope of the invention. As such, the invention is not defined by the discussion that appears above, but rather is defined by the points that follow, the respective features recited in those points, and by equivalents of such features described here and in the Figures.

What is claimed is:

1. A medicament case carrier apparatus comprising:
(a) a generally tubular body elongated along a longitudinal axis, the generally tubular body having an interior cavity and an open end, the interior cavity coextensive with the open end; the generally tubular body comprising an inner vessel having an inner surface in communication with the interior cavity, an outer surface and a top rim flange extending orthogonally from the longitudinal axis of the tubular body, an outer vessel having an inner surface, an outer surface and a top rim, the top rim flange of the inner vessel configured to be coextensive with the top rim of the outer vessel so as to form a vessel cavity between the inner surface of the outer vessel and the outer surface of the inner vessel;
(b) a removable cap that is configured to be secured at the open end for selectively allowing insertion or removal of a medicament container into or from said interior cavity; wherein the cap includes:
a. one or more a shock absorbing elements configured to extend into the interior cavity;
b. at least one input device configured to output a control signal;
c. at least one display device configured to display at least one visual indicator of a date;
d. a power source; and
e. a processor configured by code executing therein to receive a control signal, and in response to the control signal, advance a date is real time, from a first pre-set date to a second preset date and provide a notification via the output device upon reaching the second pre-set date.

2. The medicament case of claim 1, wherein an insulating layer disposed within the vessel cavity.

3. The medicament case of claim 1, further comprising a shock-absorbing material disposed within the interior cavity.

4. The medicament case of claim 1, wherein the second preset date corresponds to the expiration date or refill date of the medicament contained within the medicament case.

5. The apparatus of claim 1, where the control device includes a wireless communication device that configures the microprocessor to exchange data with one or more remote computing devices.

6. The apparatus of claim 1, wherein the power supply is a rechargeable battery integrated into the cap.

7. The apparatus of claim 4, wherein the output device is a screen integral to the cap and configured to display at least the second pre-set date.

8. The apparatus of claim 1, where the input device includes at least two buttons, where each button controls advancement of a different date characteristic.

9. The apparatus of claim 1, wherein the date characteristics include day, month, and year.

10. A medicament case carrier apparatus comprising:
(a) a generally tubular body elongated along a longitudinal axis, the generally tubular body having an interior cavity and an open end, the interior cavity coextensive with the open end; the generally tubular body comprising an inner vessel having an inner surface in communication with the interior cavity, an outer surface and a top rim flange extending orthogonally from the longitudinal axis of the tubular body, an outer vessel having an inner surface, an outer surface and a top rim, the top rim flange of the inner vessel configured to be coextensive with the top rim of the outer vessel so as to form a vessel cavity between the inner surface of the outer vessel and the outer surface of the inner vessel, and
(b) a cap at the open end for selectively allowing insertion or removal of a medicament container into or from said interior cavity; wherein the cap includes an actuated securing device configured to extend into the interior cavity;
(c) a control device that includes at least one input device, at least one output device, a timing circuit and a battery, wherein the timing circuit is configured to advance in real time, from a first pre-set date to a second preset date and provide a notification via the output device upon reaching the second pre-set date.

11. The apparatus of claim 10, wherein the actuated securing device includes an impact cushion configured to extend into the open end of the medicament case.

12. The apparatus of claim 10, wherein the generally tubular body is further provided with impact absorbing material.

13. The apparatus of claim 12, wherein the impact absorbing material is formed of an elastic material.

14. The apparatus of claim 12, wherein the impact absorbing material is deformable under external force.

15. The apparatus of claim 1, wherein the cap further includes at least shock absorbing elements configured to extend into the interior cavity, the distance between the at least two is no more than 1.0% of the total width of a cap of the medicament holder.
